(19) United States
(12) Patent Application Publication
(10) Pub. No.: US 2013/0334210 A1
(43) Pub. Date: Dec. 19, 2013

(54) INDUCTION HEATING COOKER AND CONTROL METHOD FOR SAME

(71) Applicants: Takashi Takehira, Hyogo (JP); Yuji Fujii, Hyogo (JP); Daisuke Sawada, Hyogo (JP)

(72) Inventors: Takashi Takehira, Hyogo (JP); Yuji Fujii, Hyogo (JP); Daisuke Sawada, Hyogo (JP)

(73) Assignee: PANASONIC CORPORATION, Kadoma-shi, Osaka (JP)

(21) Appl. No.: 14/002,224

(22) PCT Filed: Sep. 7, 2012
(86) PCT No.: PCT/JP2012/005689

§ 371 Date: Aug. 29, 2013

(30) Foreign Application Priority Data
Dec. 26, 2011 (JP) 2011-283193

(51) Int. Cl. H05B 6/06

(52) U.S. Cl. CPC H05B 6/065
USPC 219/662

(57) ABSTRACT

An induction cooker comprises: first and second inverters [[(11a, 11b)]] each of which is connected in parallel to the smoothing capacitor and has a DC power supply converted to AC by first and second switching elements to supply high-frequency power to first and second heating coils [[(4a, 4b)]]; first and second oscillation circuits [[(7a, 7b)]] which supply a driving signal to the respective first and second switching elements; and a control unit [[(10)]] which controls driving of the first and second oscillation circuits. The control unit [[(10)]] controls the first and second oscillation circuits by alternately driving the first and second oscillation circuits and causes a switched-off side heating coil of the first and second heating coils to maintain low-power heating without causing the switched-off side heating coil of the first and second heating coils to stop heating each time the control unit switches the first and second oscillation circuits to drive.

### TECHNICAL FIELD

The present invention relates to an induction cooker having a plurality of inverters and a control function for switching the inverters respectively to drive and a method for controlling the induction cooker.

### BACKGROUND ART

An induction cooker according to a prior art will be described with reference to a drawing.

FIG. 3 is a diagram illustrating circuitry of an induction cooker according to a prior art. As illustrated in FIG. 3, the induction cooker includes an AC power supply 21, a rectifier circuit 22, a smoothing circuit 23, first and second oscillation circuits 27a and 27b, first and second inverter circuits 31a and 31b, an input current detecting circuit 28, a zero point detecting circuit 29, and a microcomputer 30.

The rectifier circuit 22 rectifies AC power supplied from the AC power supply 21, as a commercial power supply, for example. The smoothing circuit 23 removes ripple from the rectified output from the rectifier circuit 22 for producing DC power supply. The first inverter circuit 31a includes a first heating coil 24a, a first resonant capacitor 25a, and a first switching element 26a. The second inverter circuit 31b includes a second heating coil 24b, a second resonant capacitor 25b, and a second switching element 26b. The first oscillation circuit 27a and the second oscillation circuit 27b drive the first switching element 26a and the second switching element 26b of the first inverter circuit 31a and the second inverter circuit 31b, respectively. The input current detecting circuit 28 detects the value of the input current and outputs the value to the microcomputer 30. The zero point detecting circuit 29 detects the voltage of the AC power supply 21 and outputs the voltage to the microcomputer 30. The microcomputer 30 controls the first inverter circuit 31a and the second inverter circuit 31b to oscillate based on the input values detected by the input current detecting circuit 28 and the power supply voltage detecting circuit 29.

In the above described configuration, the microcomputer 30 controls to drive the first and second oscillation circuits 27a and 27b alternately. The microcomputer 30 also calculates the power value from the current value input from the input current detecting circuit 28 and the voltage value input from the power supply voltage detecting circuit 29. The calculated power value is used for power correction or the like of the first inverter circuit 31a while the first oscillation circuit 27a is being controlled. Similarly, the power value calculated by the microcomputer 30 is used for power correction or the like of the second inverter circuit 31b while the second oscillation circuit 27b is being controlled (see, for example, Patent Document 1).

Patent Document 1: JP 2001-196156 A

### SUMMARY OF THE INVENTION

### Problem to Be Solved By the Invention

However, when it is desired to operate the first inverter circuit 31a at 2 kW and the second inverter circuit 31b at 1 kW by the oscillation circuits 27a and 27b intermittently as described above, for example, alternately in each half cycle, in the configuration of the conventional art, the first inverter circuit 31a is required to output the power of 4 kW during a half cycle to provide the average output power of 2 kW. Similarly, the second inverter circuit 31b is required to output the power of 2 kW during a half cycle to provide the average output power of 1 kW. The requirements means that the input power of the induction cooker varies as large as between 4 kW and 2 kW each time the oscillation circuits 27a and 27b are driven alternately in each half cycle. In the case of alternate heating under the above described control, the second oscillation circuit 27b is completely turned off when the output from the first oscillation circuit 27a is turned on. Therefore, a large inrush current occurs at the moment when the circuit is turned on from the off state and the charging voltage of the smoothing capacitor 23 rises, which may cause the cooker body to vibrate and, accordingly, the cookware to produce such an unusual sound as buzzing or rattling noise.

An object of the present invention is to provide an induction cooker which can solve the above described conventional problem and can prevent the cookware from producing such an unusual sound as buzzing or rattling noise which is caused by variation of the input power due to alternating driving of two inverter circuits, and a method for controlling the induction cooker.

### MEANS FOR SOLVING THE PROBLEM

In order to solve the above conventional problem, an induction cooker according to one embodiment of the present invention comprises:

a rectifier circuit which rectifies power supplied from an AC power supply;

a smoothing capacitor which smooths a rectified output from the rectifier circuit to produce DC power supply;

a first inverter which is connected in parallel to the smoothing capacitor and has the DC power supply converted to AC by a first switching element to supply high-frequency power to a first heating coil;

a second inverter which is connected in parallel to the smoothing capacitor and has the DC power supply converted to AC by a second switching element to supply high-frequency power to a second heating coil;

first and second oscillation circuits which supply a driving signal to the first and second switching elements of the respective first and second inverters; and

a control unit which controls driving of the first and second oscillation circuits, wherein

the control unit controls the first and second oscillation circuits by alternately driving the first and second oscillation circuits and causes a switched-off side heating coil of the first and second heating coil to maintain low-power heating without causing the switched-off side heating coil of the first and second heating coil to stop heating each time the control unit switches the first and second oscillation circuits to drive.

### EFFECTS OF THE INVENTION

According to the above described configuration, the present invention can control the power variation resulting from the alternating driving of the two inverter circuits. Therefore, the present invention can prevent an unusual sound as buzzing or rattling noise from being produced by the cookware or reduce such sound to a level which does not annoy the user, thus, can provide a high quality induction cooker and a method for controlling the induction cooker.

### BRIEF DESCRIPTION OF THE DRAWINGS

FIG. 1 is a block diagram illustrating circuitry of an induction cooker according to an embodiment of the present invention;

FIGS. 2(A) to 2(E) are timing charts showing control timing of two oscillation circuits 7a and 7b illustrated in FIG. 1;

FIG. 3 is a block diagram illustrating circuitry of an induction cooker according to a prior art; and

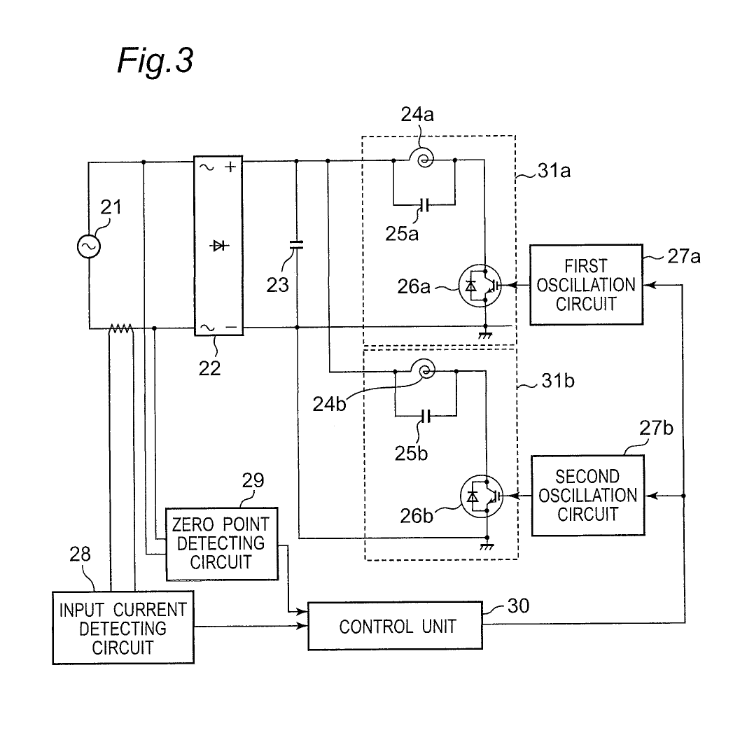

FIGS. 4(A) to 4(E) are timing charts showing control timing of oscillation circuits 27a and 27b illustrated in FIG. 3.

### DETAILED DESCRIPTION OF THE PREFERRED EMBODIMENTS

The present invention includes: a rectifier circuit which rectifies power supplied from an AC power supply; a smoothing capacitor which smooths a rectified output from the rectifier circuit to produce DC power supply; a first inverter which is connected in parallel to the smoothing capacitor and has the DC power supply converted to AC by a first switching element to supply high-frequency power to a first heating coil; a second inverter which is connected in parallel to the smoothing capacitor and has the DC power supply converted to AC by a second switching element to supply high-frequency power to a second heating coil; first and second oscillation circuits which supply a driving signal to the first and second switching elements of the respective first and second inverters; and a control unit which controls driving of the first and second oscillation circuits, wherein the control unit controls the first and second oscillation circuits by alternately driving the first and second oscillation circuits and causes a switched-off side heating coil of the first and second heating coils to maintain low-power heating without causing the switched-off side heating coil of the first and second heating coils to stop heating each time the control unit switches the first and second oscillation circuits to drive. Therefore, the present invention can suppress inrush current at the moment when the first and second oscillation circuits are turned on from the off state, prevent an unusual sound as buzzing or rattling noise from being produced by the cookware, and reduce such sound to a level which does not annoy the user.

An embodiment of the present invention will be described below with reference to the drawings. The present invention should not be limited to the embodiment.

### Embodiment

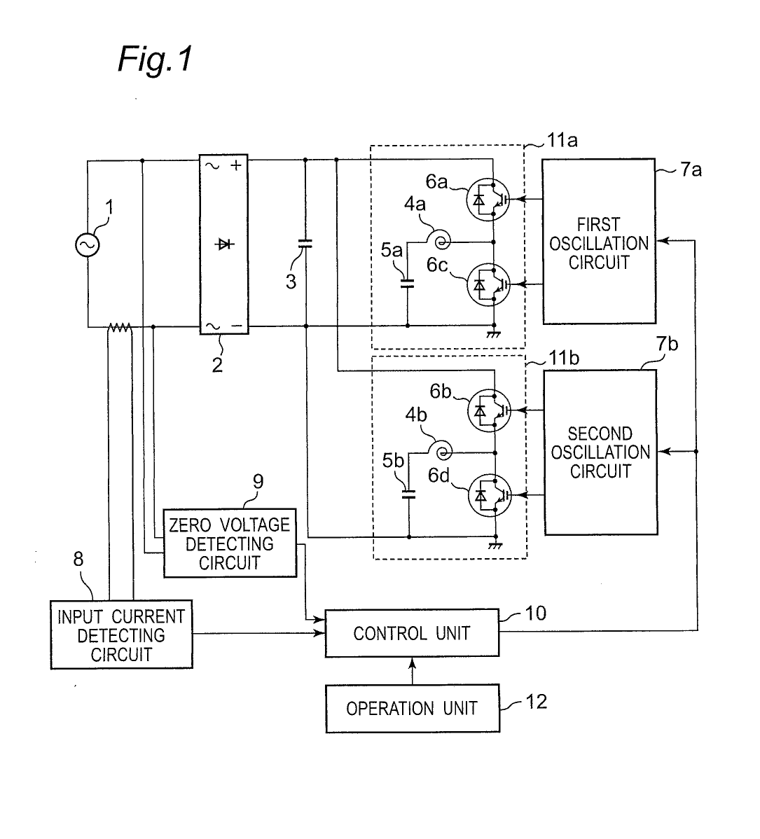

FIG. 1 is a block diagram illustrating circuitry of an induction cooker according to an embodiment of the present invention.

As illustrated in FIG. 1, the induction cooker according to the embodiment includes an AC power supply 1, a rectifier circuit 2, a smoothing circuit 3, first and second oscillation circuits 7a and 7b, first and second inverter circuits 11a and 11b, an input current detecting circuit 8, a zero voltage detecting circuit 9, a control unit 10, and an operation unit 12.

The rectifier circuit 2 rectifies AC power supplied from the AC power supply 1, as a commercial power supply, for example. The smoothing capacitor 3 removes ripple from the rectified output from the rectifier circuit 2 for producing DC power supply. The first and second inverter circuits 11a and 11b include first and second heating coils 4a and 4b, resonant capacitors 5a and 5b, first switching elements 6a and 6c, and second switching elements 6b and 6d, respectively. The first and second inverter circuits 11a and 11b are respectively connected in parallel to the smoothing capacitor 3 for respectively converting the DC power supply to AC. The first and second oscillation circuits 7a and 7b drive the respective switching elements 6a and 6c and 6b and 6d of the inverter circuits 11a and 11b. The input current detecting circuit 8 detects the value of the input current to the rectifier circuit 2 and outputs the detected value to the control unit 10. The zero voltage detecting circuit 9 detects timing (zero point) of voltage reversal between positive and negative of voltage of the AC power supply 1 and outputs the detected timing to the control unit. A user operates the operation unit 12 to select heating to an object to be heated (object to be cooked) or to adjust power. The control unit 10 has a microcomputer and controls the inverter circuits 11a and 11b to oscillate based on the input values detected by the input current detecting circuit 8 and the zero voltage detecting circuit 9 and the heating setting selected by the operation unit 12. The control unit 10 determines whether the power variation resulting from each of the switching of the first and second oscillation circuits 7a and 7b to drive is a predetermined amount or more. When the control unit 10 determines that the power variation is the predetermined amount or more, it causes a switched-off side heating coil of the first and second heating coils 4a and 4b to maintain low-power heating without causing the switched-off side heating coil to stop heating. Details will be described later.

With the above described configuration, the induction cooker according to the embodiment performs induction heating on the objects to be heated such as pans or the like placed on the first and second heating coils 4a and 4b via a top board (not shown), respectively, by eddy current caused by the magnetic coupling of the first and second heating coils 4a and 4b.

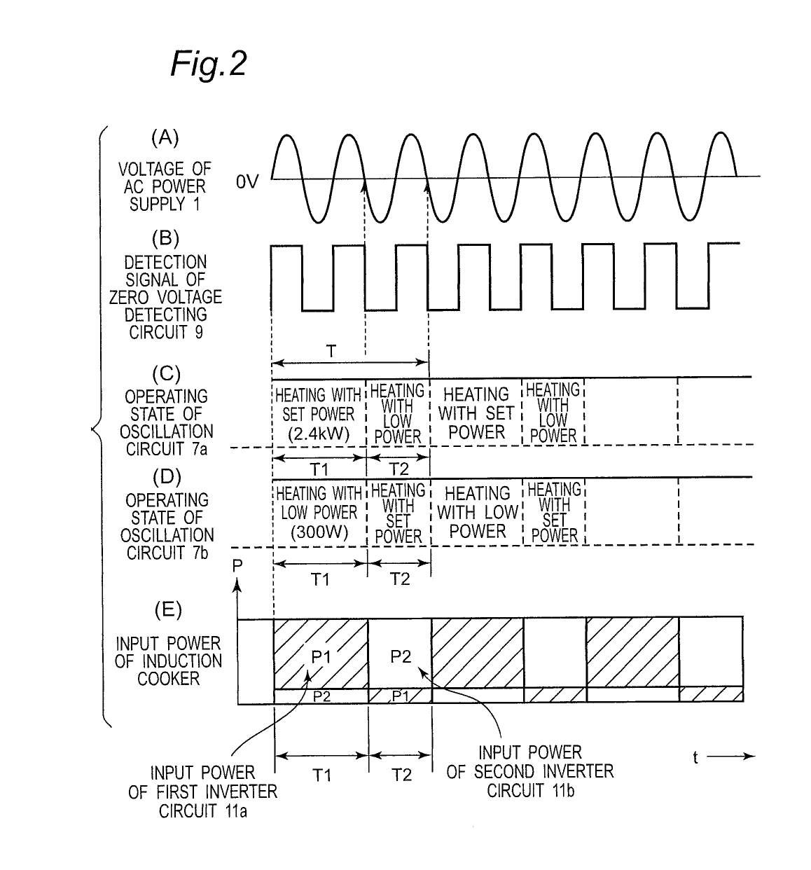

FIGS. 2(A) to 2(E) are timing charts showing control timing of two oscillation circuits 7a and 7b illustrated in FIG. 1. In FIGS. 2(A) to 2(E), FIG. 2(A) represents the voltage level of the AC power supply 1, FIG. 2(B) represents a detection signal of the zero voltage detecting circuit 9, FIGS. 2(C) and 2(D) represent respective operating states of the oscillation circuits 7a and 7b, and FIG. 2(E) represents an input power of the induction cooker.

Here, the switching elements 6a, 6c, 6b, and 6d are driven on a predetermined switching cycle, for example, a cycle as high frequency as 16 kHz or more which is inaudible to human ears without regard of the power set to the inverter circuits 11a and 11b. On-times of the switching elements 6a and 6b are controlled such that a half period of the switching cycle is the maximum on-time. Further, since the switching elements 6c and 6d and the switching elements 6a and 6b are mutually exclusively driven, on-times of the switching elements 6c and 6d are controlled such that a half period of the switching cycle is the minimum on-time. That is, when the on-times of the switching elements 6a and 6c and 6b and 6d are respectively a half of the switching cycle, the output power becomes the maximum.

Operation and effects of the induction cooker according to the present embodiment having the above described configuration will be described below.

First, when a heating operation of the inverter circuits 11a and 11b is selected by the operation unit 12, the control unit 10 receives the signal from the operation unit 12, starts sending control signals to the oscillation circuits 7a and 7b, respectively, and drives the switching elements 6a and 6c and 6b and 6d.

Control timing of the first oscillation circuit 7a by the control unit 10 is controlled such that the first oscillation circuit 7a operates during a period T1 as illustrated in FIG. 2(C). The first switching elements 6a and 6c are driven by the operation of the first oscillation circuit 7a on a high-frequency switching cycle during the period T1 for heating with the set power. The second switching elements 6b and 6d are also driven during the period T1 for heating with the low power. Control timing of the second oscillation circuit 7b is controlled such that the second oscillation circuit 7b operates during a period T2 as illustrated in FIG. 2D. The second switching elements 6b and 6d are driven by the operation of the second oscillation circuit 7b on a high-frequency switching cycle during the period T2 for heating with the set power. The first switching elements 6a and 6c are also driven during the period T2 for heating with the low power. That is, the first and second oscillation circuits 7a and 7b intermittently and alternately operate on a predetermined cycle during the periods T1 and T2, respectively, for the operation of heating with the set power and for heating with the low power. Therefore, the first switching elements 6a and 6c and the second switching elements 6b and 6d also drive intermittently and alternately on a predetermined cycle during the periods T1 and T2, respectively, for heating with a predetermined power on a high-frequency switching cycle.

Next, switching timing of the operation of the oscillation circuits 7a and 7b by the control unit 10 will be described. First, the zero voltage detecting circuit 9 detects a high-level signal at the positive side of the voltage level on the AC power supply 1, a low-level signal at the negative side, and the falling edge from the high-level to the low-level and the rising edge from the low-level to the high-level near the zero point of the voltage level as illustrated in FIGS. 2(A) and 2(B). Therefore, the detection signal is a pulse signal on a cycle of the AC power supply 1. Hereafter, the detected signal will be referred to as ZVP (zero volt pulse).

The control unit 10 detects the zero point of the AC power supply 1 by the input signal from the zero voltage detecting circuit 9, and switches the operation of the first and second oscillation circuits 7a and 7b near the zero point of the AC power supply 1. When a power variation resulting from each of the switching of the first and second oscillation circuits 7a and 7b to drive is a predetermined power or more (for example, about 2.4 kW or more, without limiting the present invention to the power), the second oscillation circuit 7b starts heating with the low power while the operation of the first oscillation circuit 7a is the heating with the set power, as illustrated in FIGS. 2C and 2D. With that operation, the control unit 10 suppresses a sudden power variation from 0 W to reduce the rising voltage resulting from the inrush current. That is, after the operation of the first oscillation circuit 7a passes the zero point of the AC power supply 1 by the low power operation (for example, about 300 W, without limiting the present invention to the power), the control unit 10 starts the operation with the set power of the second oscillation circuit 7b. The control unit 10 performs in the same manner in the case where it switches the operation from the second oscillation circuit 7b to the first oscillation circuit 7a. Since the control unit 10 switches the operation of the first and second oscillation circuits 7a and 7b near the zero point as described above, the period T1 in which the first oscillation circuit 7a operates and the period T2 in which the second oscillation circuit 7b operates are in units of the half cycle (integral multiple of the half cycle) of the cycle of the AC power supply. As illustrated in FIGS. 2(B) to 2(D), since the period T1 has three pulses of the ZVP and the period T2 has two pulses of the ZVP, the first and second oscillation circuits 7a and 7b alternately operate by a cycle of five ZVPs. Here, the heating with the low power refers to the heating with the power lower than that of the heating with the set power. For example, it is only needed to set the power in the heating with the low power such that the total power of the oscillation circuits 7a and 7b, one of which is heating with the low power, does not exceed the maximum rating of the element constituting the circuit (for example, the rectifier circuit 2). Also, it is only needed to control the respective inverters 11a and 11b to have the average outputs including the power in the heating with the low power be the set power.

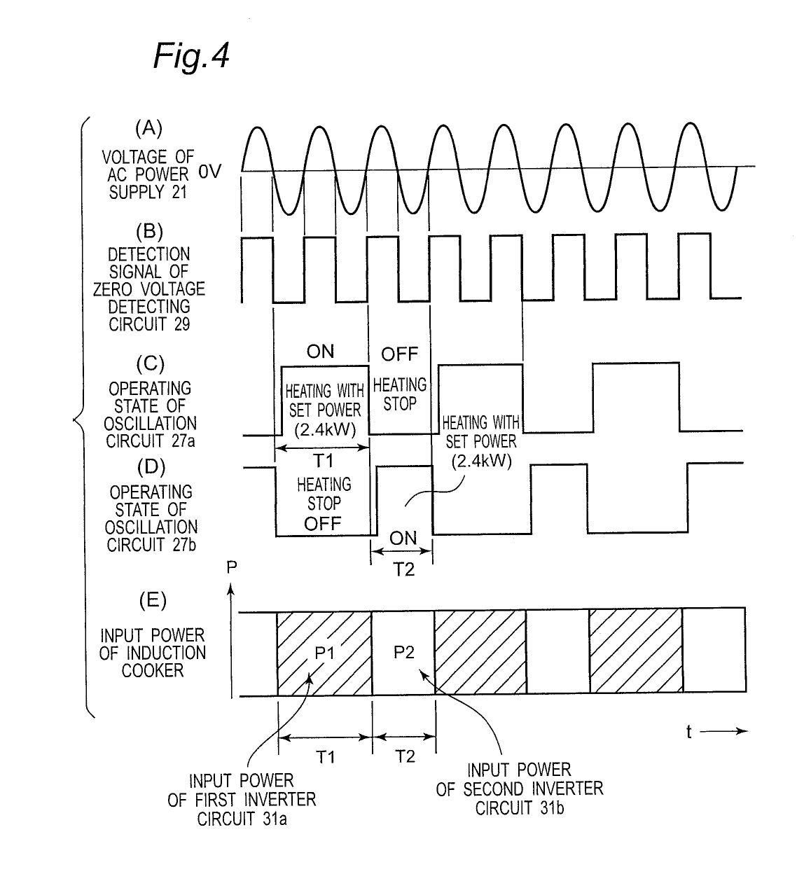

On the other hand, FIGS. 4(A) to 4(E) are timing charts showing control timing of oscillation circuits in the induction cooker according to the prior art. The voltage of the AC power supply 21 of FIG. 4(A) and a detection signal of the zero voltage detecting circuit 29 of FIG. 4(B) are the same as those of the present embodiment. However, the operating states of the oscillation circuits 27a and 27b illustrated in FIGS. 4(C) and 4(D) are such that when the first switching element 6a is turned on, the second oscillation circuit 7b is completely turned off. As a result, in the induction cooker according to the prior art, the inrush current occurs at the moment when the second oscillation circuit 7b is turned on from the off state, which causes an unusual sound as buzzing or rattling noise to be produced by the cookware. On the other hand, the present invention can prevent a buzzing or rattling noise from being produced by the cookware as described above, or reduce such sound to a level which does not annoy the user.

As described above, the induction cooker according to the present embodiment includes: a rectifier circuit 2 which rectifies power supplied from an AC power supply 1; a smoothing capacitor 3 which smooths a rectified output from the rectifier circuit to produce DC power supply; a first inverter 11a which is connected in parallel to the smoothing capacitor and has the DC power supply converted to AC by a first switching element to supply high-frequency power to a first heating coil 4a; a second inverter 11b which is connected in parallel to the smoothing capacitor and has the DC power supply converted to AC by a second switching element to supply high-frequency power to a second heating coil 4b; first and second oscillation circuits 7a and 7b which supply a driving signal to the first and second switching elements of the respective first and second inverters; and a control unit 10 which controls driving of the first and second oscillation circuits. The control unit 10 controls the first and second oscillation circuits 7a and 7b by alternately driving the first and second oscillation circuits 7a and 7b and causes a switched-off side heating coil of the first and second heating coils 4a and 4b to maintain low-power heating without causing the switched-off side heating coil of the first and second heating coils 4a and 4b to stop heating each time the control unit 10 switches the first and second oscillation circuits 7a and 7b to drive. According to the above described configuration and operation, the present invention can control the charging voltage of the smoothing capacitor 3 to be low by limiting the inrush current which occurs at the moment when the off state transits to the on state as a result of alternating driving of the two inverter circuits 11a and 11b. As a result, the present invention can prevent a buzzing or rattling noise from being produced by the cookware and reduce such sound to a level which does not annoy the user.

### INDUSTRIAL APPLICABILITY

As described in detail above, the induction cooker and the method for controlling the induction cooker according to the present invention can prevent the cookware from producing buzzing or rattling noise which is caused by power variation due to alternating driving of two inverter circuits. Therefore, the present invention can be generally applied to induction cookers which are operated by alternating driving whether they are intended for general household use or for business use.

### DESCRIPTION OF REFERENCE CHARACTERS

1 AC power supply
2 rectifier circuit
3 smoothing capacitor
4a first heating coil
4b second heating coil
6a, 6c first switching element
6b, 6d second switching element
7a first oscillation circuit
7b second oscillation circuit
10 control unit
11a first inverter circuit
11b second inverter circuit CLAIMS

1. An induction cooker comprising:
a rectifier circuit which rectifies power supplied from an AC power supply;
a smoothing capacitor which smooths a rectified output from the rectifier circuit to produce DC power supply;
a first inverter which is connected in parallel to the smoothing capacitor and has the DC power supply converted to AC by a first switching element to supply high-frequency power to a first heating coil;
a second inverter which is connected in parallel to the smoothing capacitor and has the DC power supply converted to AC by a second switching element to supply high-frequency power to a second heating coil;
first and second oscillation circuits which supply a driving signal to the first and second switching elements of the respective first and second inverters; and
a control unit which controls driving of the first and second oscillation circuits, wherein
the control unit controls the first and second oscillation circuits by alternately driving the first and second oscillation circuits and causes a switched-off side heating coil of the first and second heating coils to maintain low-power heating without causing the switched-off side heating coil of the first and second heating coils to stop heating each time the control unit switches the first and second oscillation circuits to drive.

2. The induction cooker according to claim 1, wherein
when a power variation resulting from each of the switching of the first and second oscillation circuits to drive is a predetermined amount or more, the control unit causes a switched-off side heating coil of the first and second heating coils to maintain low-power heating without causing the switched-off side heating coil of the first and second heating coils to stop heating.

3. A method for controlling an induction cooker, the induction cooker comprising: a first inverter which is connected in parallel to a smoothing capacitor and has a DC power supply converted to AC by a first switching element to supply high-frequency power to a first heating coil; a second inverter which is connected in parallel to the smoothing capacitor and has the DC power supply converted to AC by a second switching element to supply high-frequency power to a second heating coil; and first and second oscillation circuits which supply a driving signal to the first and second switching elements of the respective first and second inverters; wherein the method comprises:
a step of controlling the first and second oscillation circuits by alternately driving the first and second oscillation circuits and causing a switched-off side heating coil of the first and second heating coils to maintain low-power heating without causing the switched-off side heating coil of the first and second heating coils to stop heating each time of switching the first and second oscillation circuits to drive.

4. The method for controlling an induction cooker according to claim 3, wherein
when a power variation resulting from each of the switching of the first and second oscillation circuits to drive is a predetermined amount or more, the controlling step causes a switched-off side heating coil of the first and second heating coils to maintain low-power heating without causing the switched-off side heating coils of the first and second heating coil to stop heating.
